(19) United States
(12) Patent Application Publication
(10) Pub. No.: US 2019/0203797 A1
(43) Pub. Date: Jul. 4, 2019

(54) CYLINDER DEVICE

(71) Applicants: KYB Corporation, Tokyo (JP); FUJIKURA RUBBER LTD., Tokyo (JP)

(72) Inventors: Takao MURATA, Gifu (JP); Kazunori FUEKI, Gifu (JP); Takuya TSUKAMOTO, Fukushima (JP)

(73) Assignees: KYB Corporation, Tokyo (JP); FUJIKURA RUBBER LTD., Tokyo (JP)

(21) Appl. No.: 16/331,717

(22) PCT Filed: Sep. 6, 2017
(86) PCT No.: PCT/JP2017/032175

§ 371 Date: Mar. 8, 2019

(30) Foreign Application Priority Data
Sep. 21, 2016 (JP) 2016-184243

(51) Int. Cl. F16F 9/32

(52) U.S. Cl. CPC F16F 9/3228; F16F 9/3271; F16F 9/3214; F16F 9/3221

(57) ABSTRACT

A piston rod of a shock absorber includes a pipe material formed of a fiber material and a resin material, and connection members provided to the ends of the pipe material. The pipe material has an inner peripheral surface which has not been subjected to processing for cutting the fiber material, and the connection members have joint parts that are inserted into the inner peripheral surface and are joined to the pipe material with an adhesive.

### TECHNICAL FIELD

The present invention relates to a cylinder device.

### BACKGROUND ART

JPH04-110241U discloses a cylinder device including a piston that is slidably inserted into a cylinder and a piston rod that is connected to the piston. The piston rod of this cylinder device is formed of fiber-reinforced plastic in order to reduce the weight.

### SUMMARY OF INVENTION

Herein, in general, if a portion of the fibers in a member formed of fiber-reinforced plastic are cut by a cutting process or the like, the strength of the fiber-reinforced plastic decreases. In the cylinder device disclosed in JPH04-110241U, a cutting process is carried out to form a screw part on the end of a pipe member that constitutes the piston rod. Therefore, the fibers at the end of the pipe member are cut by the cutting process, and thus the strength of the piston rod may decrease.

An object of the present invention is to improve the strength of the piston rod.

According to one aspect of the present invention, a cylinder device includes: a cylinder in which a working fluid is filled; a piston slidably inserted into the cylinder; and a piston rod coupled to the piston and inserted into the cylinder so as to be capable of advancing and retracting with respect to the cylinder. The piston rod includes: a cylindrical member formed of a fiber material and a resin material; and a connection member provided to an end of the cylindrical member. The cylindrical member has an inner peripheral surface which has not been subjected to processing for cutting the fiber material, and the connection member has a joint part inserted into the inner peripheral surface and joined to the cylindrical member with an adhesive.

### BRIEF DESCRIPTION OF DRAWINGS

FIG. 1 is a partial cross-section view of a cylinder device according to an embodiment of the present invention;

FIG. 2 is an enlarged view of the portion labeled II in FIG. 1;

FIG. 3 is a view for explaining a gap between a connection member and a cylindrical member of the cylinder device according to the embodiment of the present invention; and

FIG. 4 is an enlarged view of a cylinder device according to an alternative example of the embodiment of the present invention.

### DESCRIPTION OF EMBODIMENTS

Embodiments of the present invention will now be explained below referring to the drawings.

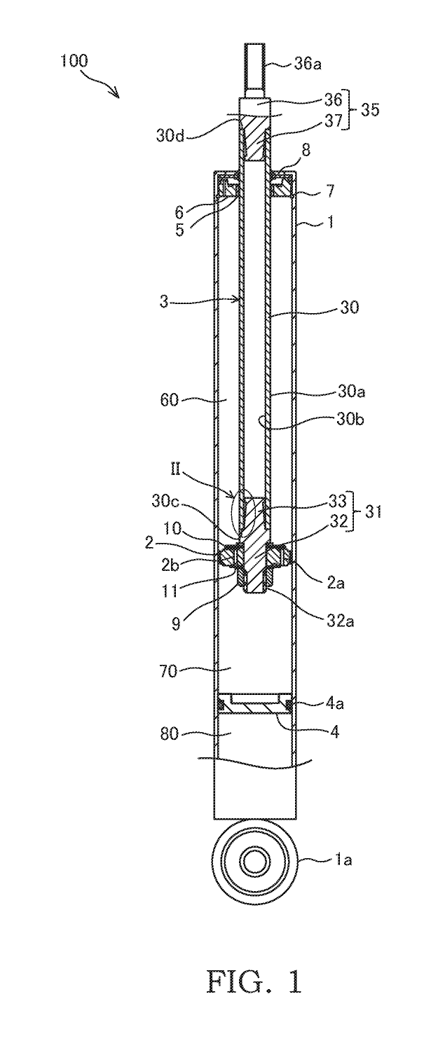

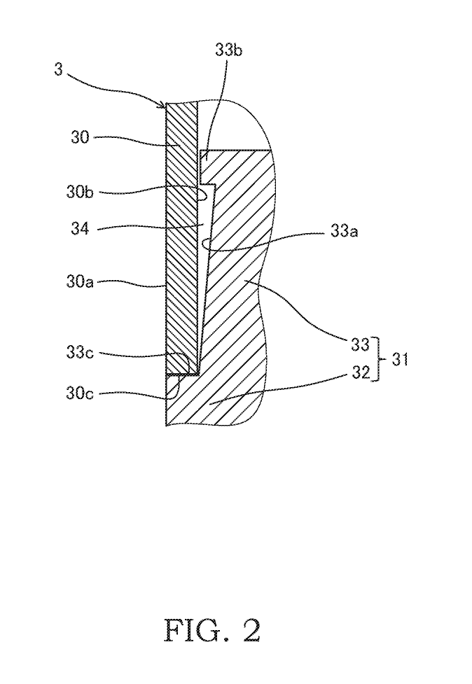

Referring to FIGS. 1 and 2, a cylinder device according to an embodiment of the present invention will be explained below.

In the present embodiment, a case in which the cylinder device is a shock absorber 100 will be explained. The shock absorber 100 is, for example, a device that is interposed between a vehicle body and a vehicle axle of a vehicle (not illustrated), and that generates a damping force to suppress vibrations of the vehicle body.

As shown in FIG. 1, the shock absorber 100 includes the following: a cylinder 1; an annular piston 2 that is slidably inserted into the cylinder 1, and that partitions the inside of the cylinder 1 into an extension-side chamber 60 and a contraction-side chamber 70; and a piston rod 3 that is coupled to the piston 2 and inserted into the cylinder 1 such that the piston rod 3 can move into and out of the cylinder 1. Hydraulic oil which serves as a working fluid is sealed in the extension-side chamber 60 and the contraction-side chamber 70.

The shock absorber 100 is a mono-tube shock absorber provided with a free piston 4 that is slidably inserted into the cylinder 1 and that partitions a gas chamber 80 on the inside of the cylinder 1. A seal member 4a that retains the air-tightness of the gas chamber 80 is provided to the outer periphery of the free piston 4.

An annular rod guide 6 that slidably supports the piston rod 3 via a bush 5 provided on the inner periphery of the rod guide 6 is fitted to the end of the cylinder 1 on the extension-side chamber 60 side. The rod guide 6 abuts a retaining ring 7 provided to the inner periphery of the cylinder 1, and thereby the position of the rod guide 6 in the axial direction is defined.

An oil seal 8 that prevents the hydraulic oil from leaking to the outside is provided to the rod guide 6 on the side opposite the extension-side chamber 60.

The rod guide 6 and the oil seal 8 are fixed to the cylinder 1 by caulking to bend the end of the cylinder 1 toward the inside.

The end of the cylinder 1 on the gas chamber 80 side is closed by a cap member (not illustrated). As shown in FIG. 1, an attachment member 1a for attaching the shock absorber 100 to the vehicle is provided to the end of the cylinder 1 on the gas chamber 80 side. The end of the cylinder 1 on the gas chamber 80 side may be closed by plastic processing instead of by providing a cap member.

When the shock absorber 100 contracts and the piston rod 3 moves into the cylinder 1, the gas of the gas chamber 80 is compressed by an amount equivalent to the volume of the piston rod 3 that has moved into the cylinder 1, and the free piston 4 moves toward the gas chamber 80 side. When the shock absorber 100 extends and the piston rod 3 moves out of the cylinder 1, the gas of the gas chamber 80 expands by an amount equivalent to the volume of the piston rod 3 that has moved out of the cylinder 1, and the free piston 4 moves toward the contraction-side chamber 70 side. Thereby, volume changes within the cylinder 1 during operation of the shock absorber 100 are compensated.

The piston rod 3 includes the following: a pipe material 30 serving as a cylindrical member; a first connection member 31 that is provided to an end of the pipe material 30 and serves as a connection member for connecting the pipe material 30 and the piston 2; and a second connection member 35 that is provided to an end of the pipe material 30 and serves as a connection member for connecting the pipe material 30 and an external member (not illustrated). The first connection member 31 and the second connection member 35 are joined to the pipe material 30 with an adhesive. The first connection member 31 is joined in a state in which the first connection member 31 abuts one end surface 30c of the pipe material 30, and the second connection member 35 is joined in a state in which the second connection member 35 abuts the other end surface 30d of the pipe material 30.

The pipe material 30 is formed in a cylindrical shape having an outer peripheral surface 30a and an inner peripheral surface 30b, and is formed of a carbon fiber-reinforced plastic (CFRP). Carbon fiber-reinforced plastic is a type of fiber-reinforced plastic (FRP) which uses carbon fibers as a reinforcing material, and is formed of solidifying the carbon fibers with a resin material such as an epoxy or polyester. As a reinforcing material, glass fibers or aramid fibers may also be used. The strength of the piston rod 3 can be improved by forming the pipe material 30 using a fiber-reinforced plastic. Further, when using carbon fibers as the reinforcing material, the strength of the pipe material 30 can be further improved, and thus the weight of the pipe material 30 can be reduced by reducing the thickness of the pipe material 30, etc.

The first connection member 31 is a columnar member formed by a metal, and the first connection member 31 includes the following: a joint part 33 that is inserted into and joined to the inner peripheral surface 30b of the pipe material 30, which has not been subjected to processing for cutting the fiber material; and a coupling part 32 that is coupled to the piston 2. Male threads 32a onto which a nut 9 is screwed are provided to the distal end of the coupling part 32. The shape of the joint part 33 will be explained below.

The second connection member 35 is a columnar member formed by a metal similar to the first connection member 31, and the second connection member 35 includes the following: a joint part 37 that is inserted into and joined to the inner peripheral surface 30b of the pipe material 30, which has not been subjected to processing for cutting the fiber material; and a coupling part 36 that is coupled to the external member. Male threads 36a which are used when coupling to the external member are provided to the distal end of the coupling part 36. The shape of the joint part 37 is the same as the shape of the joint part 33 of the first connection member 31.

In this way, the piston rod 3 is formed by inserting and joining the first connection member 31 and the second connection member 35 to the pipe material 30, which has not been subjected to processing for cutting the fiber material, e.g. a cutting process except for the processing for cutting both ends. Therefore, since the fibers of the pipe material 30 are not cut by a cutting process or the like, the strength of the piston rod 3 can be improved.

The inner peripheral surface 30b of the pipe material 30 is preferably subjected to a surface processing treatment such as blasting to an extent such that the fibers of the pipe material 30 are not cut. By increasing the surface roughness of the inner peripheral surface 30b of the pipe material 30, the contact surface area of the adhesive can be increased and the bonding strength can be improved.

Plating (not illustrated) is applied to the surface of the piston rod 3, particularly the outer peripheral surface 30a of the pipe material 30. By providing plating to the outer peripheral surface 30a of the pipe material 30, the contact between the outer peripheral surface 30a of the pipe material 30 and the oil seal 8 can be improved, and the sealing performance can be secured.

The plating is directly applied to the pipe material 30. Since the pipe material 30 is formed of a carbon fiber-reinforced plastic, the pipe material 30 possesses a certain level of electrical conductivity. Therefore, copper plating, which is easy to coat, is applied to the pipe material 30. Further, chromium plating is applied to the entire piston rod 3 including the pipe material 30 coated with the copper plating. The plating is not limited to an embodiment in which the plating is directly applied to the pipe material 30, and the piston rod 3 may be covered with a metal tube and then the chromium plating may be applied to the metal tube.

The piston 2 includes passages 2a and 2b that establish communication between the extension-side chamber 60 and the contraction-side chamber 70. A damping valve 10 having a plurality of annular leaf valves is provided to the extension-side chamber 60 side of the piston 2. Further, a damping valve 11 having a plurality of annular leaf valves is provided to the contraction-side chamber 70 side of the piston 2. The piston 2, the damping valve 10, and the damping valve 11 are fixed to the coupling part 32 of the first connection member 31 by the nut 9.

The damping valve 10 is opened by a pressure difference between the extension-side chamber 60 and the contraction-side chamber 70 during contraction of the shock absorber 100, thereby opening the passage 2a so as to apply resistance to the flow of hydraulic oil moving from the contraction-side chamber 70 to the extension-side chamber 60 through the passage 2a. Further, the damping valve 10 closes the passage 2a during extension of the shock absorber 100.

The damping valve 11 is opened during extension of the shock absorber 100, thereby opening the passage 2b so as to apply resistance to the flow of hydraulic oil moving from the extension-side chamber 60 to the contraction-side chamber 70 through the passage 2b. Further, the damping valve 11 closes the passage 2b during contraction of the shock absorber 100.

In other words, the damping valve 10 is a damping force generating element during contraction of the shock absorber 100, and the damping valve 11 is a damping force generating element during extension of the shock absorber 100.

Next, referring to FIG. 2, the joint part 33 of the first connection member 31 will be explained. FIG. 2 is an enlarged view of the encircled portion labeled II in FIG. 1.

The joint part 33 of the first connection member 31 includes the following: a tapered part 33a in which the outer diameter gradually decreases toward the end of the joint part 33; a flange part 33b that is provided closer to the end of the joint part 33 than the tapered part 33a and that has a larger diameter than the minimum outer diameter of the tapered part 33a; and a stepped part 33c that connects a maximum outer diameter part of the tapered part 33a and the coupling part 32. The outer diameter of the flange part 33b and the maximum outer diameter of the tapered part 33a are set to be smaller than the inner diameter of the pipe material 30. The stepped part 33c is formed by a flat surface that is perpendicular to the center axis of the first connection part 31.

As shown in FIG. 2, when the first connection member 31 including the joint part 33 having the above-described shape is inserted into the pipe material 30, the one end surface 30c of the pipe material 30 abuts the stepped part 33c. In this state, a retaining space 34 is defined by the inner peripheral surface 30b of the pipe material 30, the outer peripheral surface of the tapered part 33a, and the flange part 33b. An adhesive (not illustrated) is retained in the retaining space 34.

The inner peripheral surface 30b of the pipe material 30 and the outer peripheral surface of the tapered part 33a are joined with the adhesive retained in the retaining space 34, and as a result, the pipe material 30 is coupled to the first connection member 31. As the adhesive, an epoxy resin-based adhesive that has relatively high viscosity and is in the form of a starch syrup or paste is used.

Herein, in general, if the amount of adhesive that exists between two members is too large or too small, the adhesive force of the adhesive decreases. In other words, in order to increase the bonding strength between the pipe material 30 and the first connection member 31, it is necessary to provide a gap in which an adhesive of an optimal thickness is retained between the inner peripheral surface 30b of the pipe material 30 and the joint part 33 of the first connection member 31.

However, if a gap is provided between the inner peripheral surface 30b of the pipe material 30 and the joint part 33 of the first connection member 31, the first connection member 31 is prone to becoming eccentric relative to the pipe material 30 when inserting the first connection member 31 into the pipe material 30. Specifically, if the first connection member 31 becomes eccentric relative to the pipe material 30, in certain parts there may be almost no gap between the inner peripheral surface 30b of the pipe material 30 and the joint part 33 of the first connection member 31, and in certain parts the size of the gap between the inner peripheral surface 30b of the pipe material 30 and the joint part 33 of the first connection member 31 may become larger than is optimal for adhesion. Therefore, it is difficult to secure a gap that is optimal for adhesion around the entire periphery. Thus, for example, merely configuring the joint part 33 that is inserted into the pipe material 30 to have a cylindrical shape and merely providing a gap between the inner peripheral surface 30b of the pipe material 30 and the joint part 33 of the first connection member 31 may cause the thickness of the adhesive that exists between the inner peripheral surface 30b and the joint part 33 to become varied in the peripheral direction of the joint part 33. As a result, the joint strength between the pipe material 30 and the first connection member 31 may not reach a sufficient strength.

In response to the above, the joint strength between the pipe material 30 and the first connection member 31 can be improved by providing the tapered part 33a to the joint part 33.

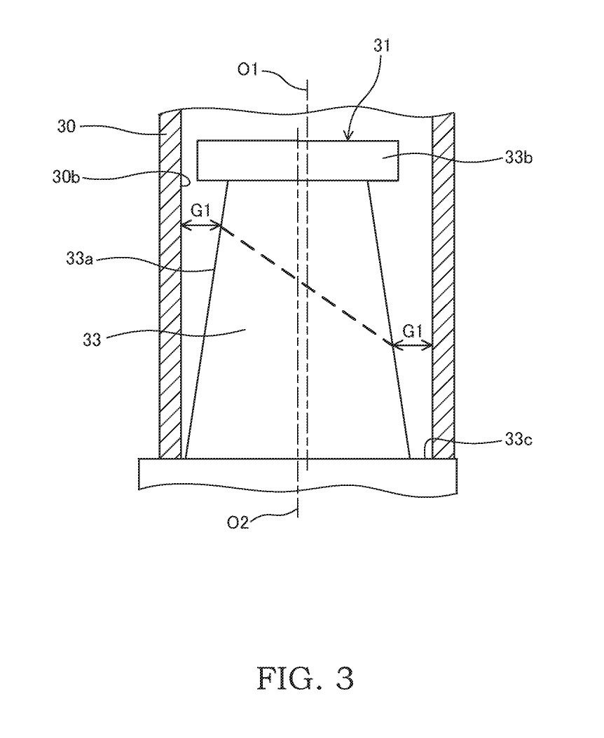

Herein, referring to FIG. 3, the gap formed between the pipe material 30 and the first connection member 31 will be explained in the case that the tapered part 33a is provided to the joint part 33. FIG. 3 is a schematic view illustrating a state in which the first connection member 31 is inserted in an eccentric manner relative to the pipe material 30.

As shown in FIG. 3, if an axial center O1 of the pipe material 30 and an axial center O2 of the first connection member 31 have deviated from each other, the interval between the inner peripheral surface 30b and the outer peripheral surface of the tapered part 33a changes in the peripheral direction. Further, since the joint part 33 is formed in a tapered shape, the interval between the inner peripheral surface 30b and the outer peripheral surface of the tapered part 33a also changes in the axial direction, and becomes narrower gradually from the flange part 33b side toward the stepped part 33c.

Therefore, on the right side in FIG. 3 where the interval between the pipe material 30 and the first connection member 31 is relatively wide, the interval between the inner peripheral surface 30b and the outer peripheral surface of the tapered part 33a reaches a thickness G1 which is optimal for the adhesive at a portion toward the stepped part 33c. On the other hand, on the left side in FIG. 3 where the interval between the pipe material 30 and the first connection member 31 is relatively narrow, the interval between the inner peripheral surface 30b and the outer peripheral surface of the tapered part 33a reaches the thickness G1 which is optimal for the adhesive at a portion toward the flange part 33b.

In this way, even in the case in which a gap is provided between the pipe material 30 and the first connection member 31 and the axial center O1 of the pipe material 30 and the axial center O2 of the first connection member 31 have deviated from each other, the interval between the inner peripheral surface 30b and the outer peripheral surface of the tapered part 33a reaches the optimal thickness G1 where the joint strength is strongest at some portion in the axial direction range in which the tapered part 33a is formed. In other words, as shown by the dashed line in FIG. 3, the portion where the thickness of the adhesive reaches the optimal thickness G1 is formed around the entire periphery and inclined relative to the axial centers O1 and O2. Therefore, the pipe material 30 and the first connection member 31 are strongly joined by the adhesive having an optimal thickness G1 around the entire periphery.

Further, since there are some uneven parts on the inner peripheral surface 30b which has not been subjected to a cutting process or the like, even if the axial center O1 of the pipe material 30 and the axial center O2 of the first connection member 31 have not deviated from each other, there are cases in which the interval between the inner peripheral surface 30b and the outer peripheral surface of the tapered part 33a is not constant in the peripheral direction. Even in such cases, the thickness of the adhesive reaches the optimal thickness G1 where the joint strength is strongest at some portion in the axial direction range in which the tapered part 33a is formed, and the portion where the thickness of the adhesive reaches the optimal thickness G1 is formed around the entire periphery. Therefore, the pipe material 30 and the first connection member 31 are strongly joined by the adhesive having an optimal thickness G1 around the entire periphery.

If the angle of the tapered part 33a is increased, the rate at which the interval between the inner peripheral surface 30b and the outer peripheral surface of the tapered part 33a changes in the axial direction increases, and the axial direction range in which the adhesive is formed at the optimal thickness decreases. Therefore, the angle of the tapered part 33a is preferably set to be as small as possible.

Next, the method for joining the pipe material 30 and the first connection member 31 will be explained.

First, the adhesive in the form of a starch syrup or paste is applied over the entirety of the tapered part 33a. Since the viscosity of the adhesive is high and the flange part 33b and the stepped part 33c are provided adjacent to the tapered part 33a, the adhesive that is applied is prevented from flowing off of the tapered part 33a.

Next, the first connection member 31 to which the adhesive has been applied is inserted into the pipe material 30. At this time, the adhesive is preferably applied to the tapered part 33a in the previous step to an extent such that a part of the adhesive is scraped off by the one end surface 30c of the pipe material 30.

The first connection member 31 is inserted until the stepped part 33c abuts the one end surface 30c of the pipe material 30. As a result, the retaining space 34 is filled with the adhesive, and the thickness of the adhesive reaches the optimal thickness where the joint strength is strongest at some portion in the axial direction range in which the tapered part 33a is formed. By hardening the adhesive having the optimal thickness, the pipe material 30 and the first connection member 31 are strongly joined.

While inserting the first connection member 31 into the pipe material 30, a part of the adhesive adheres to the one end surface 30c and the inner peripheral surface 30b and moves along the tapered part 33a toward the stepped part 33c side. Since the radial direction width of the retaining space 34 near the stepped part 33c is narrow, the retaining space 34 is definitively filled by the adhesive that has moved. Therefore, the angle and diameter of the tapered part 33a are preferably set so that the thickness of the adhesive reaches the optimal thickness at a portion near the stepped part 33c.

The second connection member 35 has the same shape as the first connection member 31, and thus the second connection member 35 is abutted and joined to the other end surface 30d of the pipe material 30 by the same method as the first connection member 31.

According to the above-described embodiment, the following effects are achieved.

The piston rod 3 of the shock absorber 100 is formed by inserting and joining the first connection member 31 and the second connection member 35 to the pipe material 30 which has not been subjected to any processing for cutting the fiber material except for the processing for cutting both ends. Since the fibers of the pipe material 30 are not cut by a cutting process or the like, the strength of the piston rod 3 can be improved.

Since the tapered part 33a is provided to the joint part 33 of the first connection member 31, the adhesive having a thickness at which the joint strength is strongest is interposed around the entire periphery between the inner peripheral surface 30b and the outer peripheral surface of the tapered part 33a. Therefore, the first connection member 31 and the second connection member 35 can be strongly joined to the inner peripheral surface 30b which has not been subjected to a cutting process or the like.

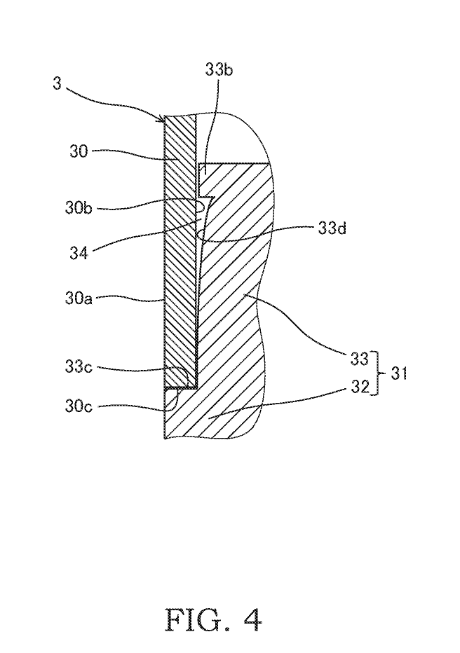

Next, referring to FIG. 4, an alternative example of the shock absorber 100 according to the embodiment of the present invention will be explained. FIG. 4 is an enlarged cross-section view corresponding to FIG. 2.

In the above-described embodiment, the size of the outer diameter of the tapered part 33a changes at a fixed rate. Instead of this, a tapered part 33d may be formed so as to bulge toward the outside in the radial direction.

In this alternative example, the rate at which the interval between the inner peripheral surface 30b and the outer peripheral surface of the tapered part 33a changes in the axial direction decreases toward the stepped part 33c side. Therefore, a region in which the interval between the inner peripheral surface 30b and the outer peripheral surface of the tapered part 33a does not change much is provided near the stepped part 33c. As a result, the range in which the thickness of the adhesive reaches an optimal thickness can be expanded in the axial direction compared to the case of the above-described embodiment. In this alternative example, since the range in which the thickness of the adhesive reaches an optimal thickness is expanded, the joint strength between the pipe material 30 and the first connection member 31 can be further improved.

The other constitutions and functions are the same as in the above-described embodiment, and thus explanations thereof will be omitted. The same effects as those of the above-described embodiment are also achieved by this alternative example.

In the following, the constitutions, operations, and effects of the embodiments of the present invention will be summarized.

The shock absorber 100 includes the following: the cylinder 1 in which hydraulic oil is filled; the piston 2 that is slidably inserted into the cylinder 1; and the piston rod 3 that is coupled to the piston 2 and inserted into the cylinder 1 such that the piston rod 3 is capable of advancing and retracting with respect to the cylinder 1. The piston rod 3 includes the pipe material 30 formed of a fiber material and a resin material, and the connection members 31, 35 provided to the ends of the pipe material 30. The pipe material 30 includes the inner peripheral surface 30b which has not been subjected to processing for cutting the fiber material, and the connection members 31, 35 include the joint parts 33, 37 that are inserted into the inner peripheral surface 30b and are joined to the pipe material 30 with the adhesive.

In the above constitution, the piston rod 3 is formed by inserting and joining the joint parts 33, 37 of the connection members 31, 35 to the pipe material 30 having the inner peripheral surface 30b which has not been subjected to processing for cutting the fiber material, e.g. a cutting process. Since the fibers of the pipe material 30 are not cut by the cutting process, etc., the strength of the piston rod 3 can be improved.

The joint part 33 includes the tapered part 33a, 33d formed in a tapered shape in which the outer diameter gradually decreases toward the end of the joint part 33. The adhesive is retained between the inner peripheral surface 30b of the pipe material 30 and the outer peripheral surface of the tapered part 33a, 33d.

In this constitution, the tapered part 33a is provided to the joint part 33, and the interval between the inner peripheral surface 30b and the outer peripheral surface of the tapered part 33a changes in the axial direction. Therefore, the thickness of the adhesive interposed between the inner peripheral surface 30b and the outer peripheral surface of the tapered part 33a reaches the thickness G1 where the joint strength is strongest at some portion in the axial direction, and the portion where the thickness of the adhesive reaches the optimal thickness G1 is formed around the entire periphery. Therefore, even if a gap is provided between the pipe material 30 and the first connection member 31, the pipe material 30 and the first connection member 31 are strongly joined by the adhesive. Further, even if there are some uneven parts on the inner peripheral surface 30b which has not been subjected to a cutting process or the like, the portion where the thickness of the adhesive reaches the optimal thickness G1 is formed around the entire periphery, and thus the pipe material 30 and the first connection member 31 are strongly joined by the adhesive.

The joint part 33 also includes the flange part 33b that is provided closer to the end of the joint part 33 than the tapered part 33a, 33d and that has a larger diameter than the minimum outer diameter of the tapered part 33a, 33d. The adhesive is retained in the retaining space 34 surrounded by the inner peripheral surface 30b of the pipe material 30, the outer peripheral surface of the tapered part 33a, 33d, and the flange part 33b.

In this constitution, since the flange part 33b is provided adjacent to the tapered part 33a, the adhesive that is applied to the tapered part 33a is prevented from flowing off of the tapered part 33a. Further, even after the joint part 33 is inserted into the pipe material 30, the adhesive is prevented from flowing out by the flange part 33b. Therefore, the retaining space 34 can be easily filled with the adhesive, and the joint formed by the adhesive can be reliably achieved. In addition, since it is not necessary to pay attention to the application state of the adhesive, the operability of the assembly operation using the adhesive can be improved.

The tapered part 33d is formed so as to bulge toward the outside in the radial direction.

In this constitution, a region in which the rate at which the interval between the inner peripheral surface 30b and the outer peripheral surface of the tapered part 33a changes in the axial direction is relatively small is provided near the stepped part 33c. Therefore, the range in which the thickness of the adhesive reaches an optimal thickness can be expanded in the axial direction. As a result, the joint strength between the pipe material 30 and the first connection member 31 can be further improved.

The fiber material includes carbon fibers.

In this constitution, carbon fibers are used as the fiber material for forming the pipe material 30. Therefore, the strength of the piston rod 3 can be improved, and the weight of the pipe material 30 can be reduced.

The first connection member 31 has the coupling part 32 that is coupled to the piston 2.

In this constitution, the piston 2 is coupled to the piston rod 3 via the coupling part 32 of the first connection member 31. By providing the first connection member 31 with an area for coupling the piston 2 and the piston rod 3 in this way, it is no longer necessary to separately provide a member for coupling the piston 2 and the piston rod 3. Thus, the constitution of the shock absorber 100 can be simplified and the manufacturing costs can be decreased.

The connection members 31, 35 are respectively provided on both ends of the pipe material 30.

In this constitution, the first connection member 31 and the second connection member 35 are provided on both ends of the pipe material 30. In other words, the piston rod 3 is formed by coupling the first connection member 31 and the second connection member 35 to both ends of the pipe material 30 having the inner peripheral surface 30b which has not been subjected to processing for cutting the fiber material. Since the piston rod 3 is formed without cutting the fibers of the pipe material 30 by a cutting process, etc., the overall strength of the piston rod 3 can be improved.

Embodiments of the present invention were described above, but the above embodiments are merely examples of applications of the present invention, and the technical scope of the present invention is not limited to the specific constitutions of the above embodiments.

For example, in the above-described embodiments, the shock absorber 100 was described as an example of the cylinder device. However, any device can be used as the cylinder device as long as it is provided with a piston rod, and for example, an actuator may be used. Further, in the above-described embodiments, a single-rod cylinder device in which the rod protrudes from one end of the cylinder was described as an example of the cylinder device. However, the cylinder device may be a double-rod cylinder device in which the rod protrudes from both ends of the cylinder.

In the above-described embodiments, the inner space of the pipe material 30 is closed by the first connection member 31 and the second connection member 35. Instead of this constitution, communication holes that communicate with the inner space of the pipe material 30 may be formed in the first connection member 31 and the second connection member 35 so that the inner space of the pipe material 30 can be used as a flow path through which a working fluid flows.

In the above-described embodiments, hydraulic oil is used as the working liquid, but another liquid such as water may be used.

This application claims priority based on Japanese Patent Application No. 2016-184243 filed with the Japan Patent Office on Sep. 21, 2016, the entire contents of which are incorporated into this specification by reference.

1. A cylinder device comprising:
a cylinder in which a working fluid is filled;
a piston slidably inserted into the cylinder; and
a piston rod coupled to the piston and inserted into the cylinder so as to be capable of advancing and retracting with respect to the cylinder,
wherein the piston rod comprises:
a cylindrical member formed of a fiber material and a resin material; and
a connection member provided to an end of the cylindrical member,
wherein the cylindrical member has an inner peripheral surface which has not been subjected to processing for cutting the fiber material, and
wherein the connection member has a joint part inserted into the inner peripheral surface and joined to the cylindrical member with an adhesive.

2. The cylinder device according to claim 1, wherein the joint part has a tapered part formed in a tapered shape in which the outer diameter gradually decreases toward an end of the joint part, and
the adhesive is retained between the inner peripheral surface of the cylindrical member and an outer peripheral surface of the tapered part.

3. The cylinder device according to claim 2, wherein the joint part further has a flange part provided closer to the end of the joint part than the tapered part, the flange part having a larger diameter than a minimum outer diameter of the tapered part, and
the adhesive is retained in a space surrounded by the inner peripheral surface of the cylindrical member, the outer peripheral surface of the tapered part, and the flange part.

4. The cylinder device according to claim 2, wherein the tapered part is formed so as to bulge toward the outside in the radial direction.

5. The cylinder device according to claim 1, wherein the fiber material includes carbon fibers.

6. The cylinder device according to claim 1, wherein the connection member further comprises a coupling part coupled to the piston.

7. The cylinder device according to claim 1, wherein the connection member is provided on each of both ends of the cylindrical member.
